(19) United States
(12) Patent Application Publication
(10) Pub. No.: US 2011/0116544 A1
(43) Pub. Date: May 19, 2011

(54) METHODS OF INTRA PREDICTION, VIDEO ENCODER, AND VIDEO DECODER THEREOF

(76) Inventors: Chih-Ming Fu, Hsinchu City (TW); Yu-Wen Huang, Taipei City (TW); Shaw-Min Lei, Taipei County (TW)

(21) Appl. No.: 12/811,701

(22) PCT Filed: Jun. 9, 2010
(86) PCT No.: PCT/CN2010/073708

§ 371 Date: Jul. 5, 2010

Related U.S. Application Data
(60) Provisional application No. 61/222,503, filed on Jul. 2, 2009.

(51) Int. Cl. H04N 7/32; H04N 7/50

(52) U.S. Cl. 375/240.12; 375/E07.243; 375/E07.214

(57) ABSTRACT

A method of intra prediction includes the steps of: receiving a video input having a plurality of blocks; encoding and reconstructing the plurality of blocks one by one; after encoding and reconstructing a designated block of the plurality of blocks to generate a designated reconstructed block, performing a deblocking operation upon the designated reconstructed block so as to generate a reference block with at least one sample being deblocked; and performing an intra prediction operation upon a current block by using samples of the reference block generated by the deblocking operation.

### CROSS REFERENCE TO RELATED APPLICATIONS

The present disclosure claims the benefit of U.S. Provisional Application No. 61/222,503, filed Jul. 2, 2009, and included herein by reference.

### TECHNICAL FIELD

The present disclosure relates to methods of intra prediction and related video encoder and video decoder, and more particularly, to methods and related video encoder and video decoder for performing an intra prediction operation upon blocks of a video input or a bitstream by using partially-deblocked samples.

### BACKGROUND

For a video encoder, such as an H.264/AVC video encoder, a deblocking operation is applied to reconstructed frames in order to reduce blocking distortion, such that sharp edges between blocks (e.g. 4×4 or 8×8 transform blocks, macroblocks) in the luminance and chrominance planes can be smoothed to improve the prediction performance. As a result, compression performance can be improved. A video decoder, such as an H.264/AVC video decoder, also uses a deblocking operation to minimize the blocking artifact between blocks of reconstructed frames. However, currently a conventional deblocking operation is a frame-level process; that is to say, the conventional deblocking operation is performed only after “one frame” is completely encoded. As a result, the conventional deblocking operation requires a large frame buffer and is hard to be parallelized.

### SUMMARY

It is an objective of the claimed disclosure to provide architectures allow parallel or pipelined encoding/decoding by performing deblocking locally.

According to an embodiment of the present disclosure, a method of intra prediction for video encoding is provided. The method includes the steps of: receiving a video input having a plurality of blocks; encoding and reconstructing the plurality of blocks one by one; after encoding and reconstructing a designated block of the plurality of blocks to generate a designated reconstructed block, performing a deblocking operation upon the designated reconstructed block so as to generate a reference block with at least one sample being deblocked; and performing an intra prediction operation upon a current block of the plurality of blocks by using samples of the reference block generated by the deblocking operation so as to generate a first intra prediction result.

According to another embodiment of the present disclosure, a video encoder is provided. The video encoder includes a reconstruction module, a deblocking module, and an intra prediction module. The reconstruction module reconstructs a video input having a plurality of blocks one by one, wherein after a designated block of the plurality of blocks is reconstructed by the reconstruction module, a designated reconstructed block is generated. The deblocking module performs a deblocking operation upon the designated reconstructed block so as to generate a reference block with at least one sample being deblocked. The intra prediction module receives the video input and performs an intra prediction operation upon a current block of the plurality of blocks by using samples of the reference block generated by the deblocking operation so as to generate a first intra prediction result.

According to still another embodiment of the present disclosure, a method of intra prediction for video decoding is provided. The method includes the steps of: receiving a bitstream, and performing entropy decoding upon the bitstream to generate T/Q residues; performing inverse transformation and inverse quantization upon the T/Q residues to generate residues; reconstructing a plurality of blocks one by one; after reconstructing a designated block to generate a designated reconstructed block, performing a deblocking operation upon the designated reconstructed block so as to generate a reference block with at least one sample being deblocked; and performing an intra prediction operation upon a current block by using samples of the reference block generated by the deblocking operation.

According to still another embodiment of the present disclosure, a video decoder is provided. The video decoder includes an entropy decoding module, an IT/IQ module, a reconstruction module, a deblocking module, and an intra prediction module. The entropy decoding module receives a bitstream, and performs entropy decoding upon the bitstream to generate T/Q residues. The IT/IQ module is coupled to the entropy decoding module, for performing inverse transformation and inverse quantization upon the T/Q residues to generate residues. The reconstruction module is coupled to the IT/IQ module, for reconstructing a plurality of blocks, wherein after a designated block is reconstructed by the reconstruction module, a designated reconstructed block is generated. The deblocking module is coupled to the reconstruction module, for performing a deblocking operation upon the designated reconstructed block so as to generate a reference block with at least one sample being deblocked. The intra prediction module performs an intra prediction operation upon a current block by using samples of the reference block generated by the deblocking operation.

### BRIEF DESCRIPTION OF DRAWINGS

These and other objectives of the present disclosure will no doubt become obvious to those of ordinary skill in the art after reading the following detailed description of the preferred embodiment that is illustrated in the various figures and drawings.

FIG. 1 is a diagram illustrating a conventional deblocking operation.

FIG. 2 is a diagram illustrating a localized deblocking operation according to a first embodiment of the present disclosure.

FIG. 3 is a diagram illustrating a localized deblocking operation according to a second embodiment of the present disclosure.

FIG. 4 is a block diagram illustrating a video encoder according to an embodiment of the present disclosure.

FIG. 5 is a flowchart illustrating a method of intra prediction for video encoding according to an embodiment of the present disclosure.

FIG. 6 is a block diagram illustrating a video encoder according to another embodiment of the present disclosure.

FIG. 7 is a flowchart illustrating a method of intra prediction for video encoding according to another embodiment of the present disclosure.

FIG. 8 is a block diagram illustrating a video decoder according to an embodiment of the present disclosure.

FIG. 9 is a flowchart illustrating a method of intra prediction for video decoding according to an exemplary embodiment of the present disclosure.

FIG. 10 is a block diagram illustrating a video decoder according to another embodiment of the present disclosure.

FIG. 11 is a flowchart illustrating a method of intra prediction for video decoding according to another exemplary embodiment of the present disclosure.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

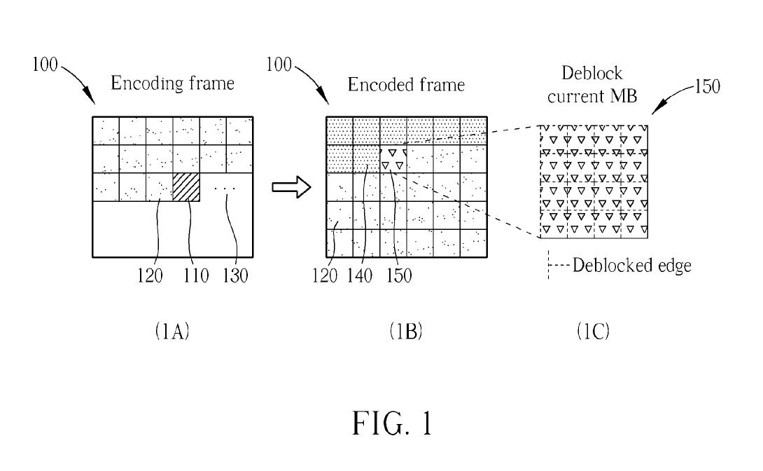

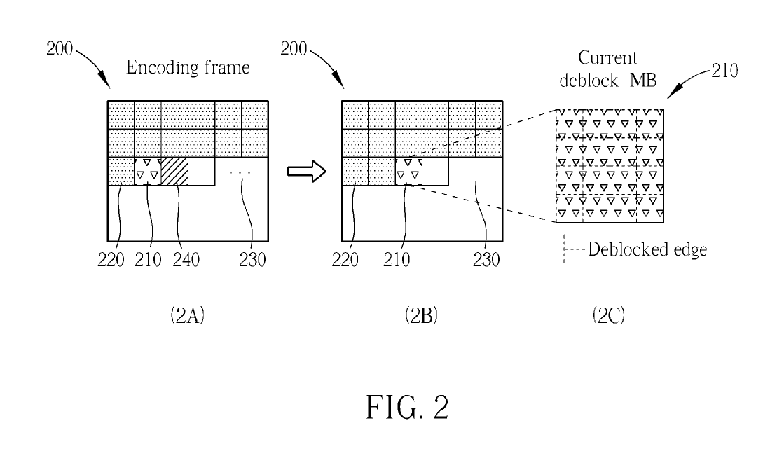

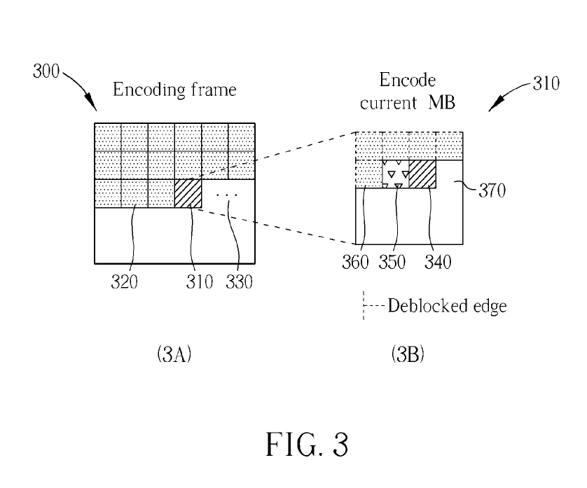

First, in order to make the specification of the present disclosure easy to understand, a brief description of the deblocking operation is given as below. Please refer to FIG. 1, FIG. 2, together with FIG. 3. FIG. 1 (including 1A, 1B, and 1C) is a diagram illustrating a conventional deblocking operation, FIG. 2 (including 2A, 2B, and 2C) is a diagram illustrating a localized deblocking operation according to a first embodiment of the present disclosure, and FIG. 3 (including 3A and 3B) is a diagram illustrating a localized deblocking operation according to a second embodiment of the present disclosure.

In FIG. 1, the conventional deblocking operation is a frame-level process. That is to say, after one frame 100 is completely encoded, the deblocking operation will be processed upon each macroblock (MB). As shown in 1A, the frame 100 has a plurality of macroblocks, wherein MB 110 represents a macroblock being currently encoded, MB 120 represents a reconstructed encoded macroblock, and MB 130 represents a non-encoded macroblock. As shown in 1B, the frame 100 is completely encoded, and thus the deblocking operation can be processed upon each macroblock one by one. Herein MB 120 represents the reconstructed encoded macroblock, MB 140 represents a reconstructed deblocked macroblock, and MB 150 represents a macroblock being currently deblocked. As shown in 1C, the macroblock 150 being currently deblocked further includes a plurality of blocks, and vertical edges and horizontal edges are existed between these blocks to be deblocked. Since the conventional deblocking operation is performed only after the frame 100 is completely encoded, the conventional deblocking operation requires a large frame buffer to store these reconstructed encoded macroblocks and the encoding process is hard to be parallelized.

In FIG. 2, the localized deblocking operation is a macroblock-level process. That is to say, after one macroblock is encoded, the deblocking operation will be processed upon the macroblock immediately. As shown in 2A, a frame 200 has a plurality of macroblocks, wherein MB 210 represents a macroblock being currently deblocked, MB240 represents a macroblock being currently encoded, MB 220 represents a reconstructed deblocked macroblock, and MB 230 represents a non-encoded macroblock. As shown in 2B, MB 240 represents a macroblock being currently encoded, MB 220 also represents the reconstructed deblocked macroblock, and MB 210 represents the macroblock being currently deblocked. As shown in 2C, the macroblock 210 being currently deblocked further includes a plurality of blocks, and vertical edges and horizontal edges are existed between these blocks to be deblocked. As one can see from FIG. 2, the localized deblocking operation is performed right after one macroblock is encoded, therefore, it is good for pipelined or parallel encoder architectures. This localized deblocking operation is also applicable for decoder. The deblocking process can be applied to a macroblock right after decoding and reconstruction, so deblocked or partial deblocked data can be used in intra prediction.

In FIG. 3, the localized deblocking operation is performed at transform-block-level. That is to say, after one transform block is encoded, the deblocking operation will be processed upon the transform block immediately. Please note that a size of the transform block is typically smaller than a size of the macroblock. For example, a macroblock may have 16×16 pixels, while a transform block may have 4×4 or 8×8 pixels. As shown in 3A, a frame 300 has a plurality of macroblocks, wherein MB 310 represents a macroblock being currently encoded, MB 320 represents a reconstructed deblocked macroblock, and MB 330 represents a non-encoded macroblock. As shown in 3B, the macroblock 310 further includes a plurality of transform blocks, wherein block 340 represents a transform block being currently encoded, block 350 represents a transform block being currently deblocked, block 360 represents a reconstructed deblocked transform block, and block 370 represents a non-encoded transform block. In addition, vertical edges and horizontal edges are existed between these transform blocks to be deblocked. As one can see from FIG. 3, the localized deblocking operation is performed right after one transform block is encoded, this kind of localized deblocking allows pipelined or parallel encoder architectures. Similarly, this transform-block-level localized deblocking is applicable in decoder so deblocked or partial deblocked data can be used in intra prediction.

In another embodiment, the localized deblocking operation can be performed at a block size different from the transform block size, for example, the deblocking operation is performed when an 8×8 block size is ready while the transform operation is proceeded in 4×4 blocks.

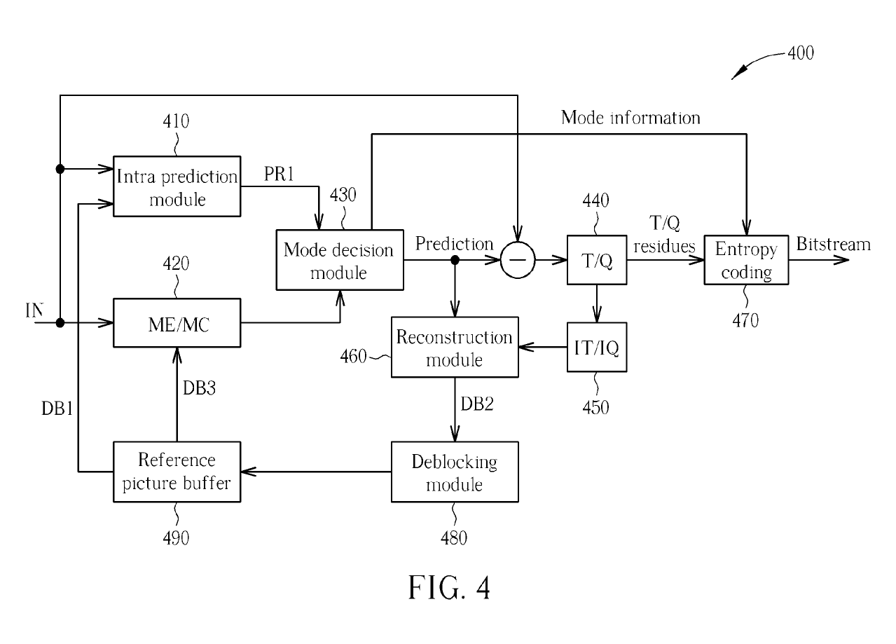

Please refer to FIG. 4. FIG. 4 is a block diagram illustrating a video encoder 400 according to an embodiment of the present disclosure. As shown in FIG. 4, the video encoder 400 includes, but is not limited to, an intra prediction module 410, a motion estimation/motion compensation module (ME/MC) 420, a mode decision module 430, a transformation/quantization module (T/Q) 440, an inverse transformation/inverse quantization module (IT/IQ) 450, a reconstruction module 460, an entropy coding module 470, a deblocking module 480, and a reference picture buffer 490. Be noted that, since operations of the ME/MC 420, the mode decision module 430, the T/Q 440, the IT/IQ 450, and the entropy coding module 470 are already well-known to a person of average skill in the pertinent art, therefore, additional description is omitted here for brevity.

First, a video input IN is inputted to the video encoder 400. After the video input IN is processed by a loop including the mode decision module 430, the T/Q 440, and the IT/IQ 450, the reconstruction module 460 reconstructs the plurality of blocks of the video input IN one by one. For example, after a designated block A of the plurality of blocks is reconstructed by the reconstruction module 460, a designated reconstructed block A′ is generated. After the designated block A is reconstructed by the reconstruction module 460 to generate the designated reconstructed block A′, the deblocking module 480 performs a deblocking operation upon the designated reconstructed block A′ so as to generate partially-deblocked samples DB1, which represents reference blocks with at least one sample being deblocked in the present disclosure. The reference picture buffer 490 is coupled to the deblocking module 480, for storing the partially-deblocked samples DB1 of reference blocks and for updating the partially-deblocked samples DB1 in order to generate fully-deblocked samples DB3 for ME/MC 420. The reference picture buffer 490 provides the partially-deblocked samples DB1 to the intra prediction module 410 and provides the fully-deblocked samples DB3 for the ME/MC 420 for subsequent operations. Furthermore, the designated reconstructed blocks A′ can also be called as non-deblocked samples DB2 because it has not been inputted into and processed by the deblocking module 480.

What calls for special attention is that, in the embodiment, the intra prediction module 410 performs an intra prediction operation upon a current block of the video input IN by using the partially-deblocked samples DB1 of reference blocks so as to generate a first intra prediction result PR1 rather than using the non-deblocked samples DB2. If the non-deblocked samples DB2 are used for the intra prediction operation, extra line buffers are required in order to store the non-deblocked samples DB2 as reference pixels for decoding next neighboring blocks. For this reason, extra line buffers can be saved when performing the intra prediction operation according to the partially-deblocked samples DB1. Additionally, a higher encoding efficiency may be achieved.

As the name implies, the abovementioned non-deblocked samples DB2 indicate that they are pixels of blocks with all neighboring edges not been deblocked; the fully-deblocked samples DB3 indicate that they are pixels of blocks with all neighboring edges been fully deblocked; while the partially-deblocked samples DB1 indicate that they are pixels of blocks with their left edges and upper edges been deblocked and their right edges and lower edges not been deblocked.

Please also note that the video input IN may conform to an H.264/AVC specification, and thus the video encoder 400 can be implemented by an H.264/AVC encoder, but the present disclosure is not limited to this only, any later version of video coding can also apply localized deblocking concept to improve encoding performance. Furthermore, in one embodiment, the abovementioned designated block A may be a macroblock, and the designated reconstructed block A′ may be a macroblock as well. In another embodiment, the designated block A may be a transform block, and the designated reconstructed block A′ may be a transform block as well. But this in no way should be considered as a limitation of the present disclosure. Certainly, those skilled in the art should appreciate that various modifications of the size of the designated block A as well as the designated reconstructed block A′ may be made without departing from the spirit of the present disclosure.

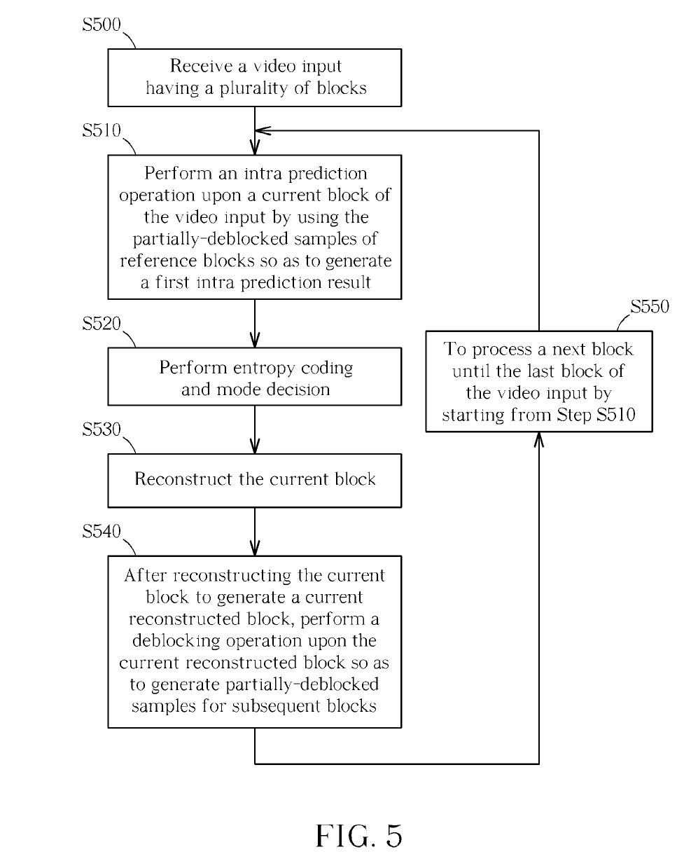

Please refer to FIG. 5. FIG. 5 is a flowchart illustrating a method of intra prediction for video encoding according to a first embodiment of the present disclosure. Please note that the following steps are not limited to be performed according to the exact order shown in FIG. 5 if a roughly identical result can be obtained. The method includes, but is not limited to, the following steps:

Step S500: Receive a video input having a plurality of blocks.

Step S510: Perform an intra prediction operation upon a current block of the video input by using the partially-deblocked samples of reference blocks so as to generate a first intra prediction result.

Step S520: Perform entropy coding and mode decision.

Step S530: Reconstruct the current block.

Step S540: After reconstructing the current block to generate a current reconstructed block, perform a deblocking operation upon the current reconstructed block so as to generate partially-deblocked samples for subsequent blocks.

Step S550: To process a next block until the last block of the video input by starting from Step S510.

The deblocking block in this embodiment can be a macroblock, a transform-block, or any other block sizes, that is the same or different from the size of a coding block or transform block.

How each element operates can be known by collocating the steps shown in FIG. 5 and the elements shown in FIG. 4, and further description is omitted here for brevity. Be noted that the steps S500 and S510 are executed by the intra prediction module 410, the step S520 is executed by the mode decision module 430 and the entropy coding module 470, the step S530 is executed by the reconstruction module 460, and the step S540 is executed by the deblocking module 480. Furthermore, in this embodiment, the intra prediction operation is performed upon the current block of the video input by using the partially-deblocked samples DB1 of reference blocks.

The embodiment above is presented merely for describing features of the present disclosure, and in no way should be considered as limitations of the scope of the present disclosure. Certainly, people skilled in the art will readily appreciate that other designs for implementing the video encoder 400 are feasible.

In another embodiment, when intra compensation is allowed in video coding, a current block may reference to a reference block in the same frame that is fully-deblocked or a reference block that is only partially-deblocked.

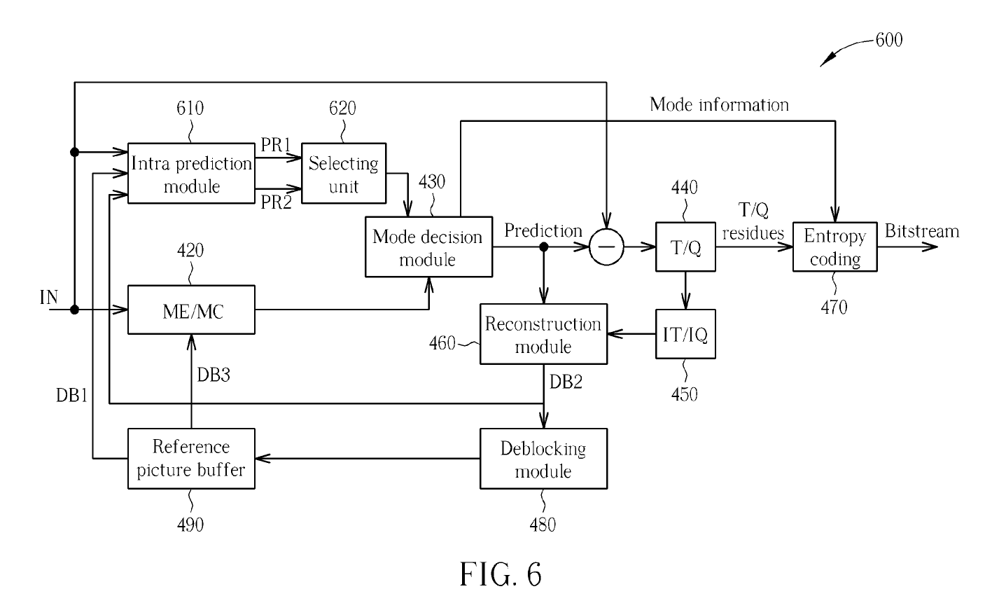

Please refer to FIG. 6. FIG. 6 is a block diagram illustrating a video encoder 600 according to another embodiment of the present disclosure. In FIG. 6, the architecture of the video encoder 600 is similar to that of the video encoder 400 shown in FIG. 4, and the difference between them is that the video encoder 600 further includes a selecting unit 620 coupled to the intra prediction module 610. In this embodiment, both the partially-deblocked samples DB1 and the non-deblocked samples DB2 of reference blocks are inputted into the intra prediction module 610. As a result, the intra prediction module 610 performs the intra prediction operation upon the current block of the video input IN by using the partially-deblocked samples DB1 of reference blocks so as to generate a first intra prediction result PR1, and performs the intra prediction operation upon the current block of the video input IN by using the non-deblocked samples DB2 of reference blocks so as to generate a second intra prediction result PR2. After that, the selecting unit 620 selects the first intra prediction result PR1 or the second intra prediction result PR2 as a resultant intra prediction result, for example, by reference to rate-distortion optimization. In other words, the mode decision module 430 performs mode decision according to the resultant intra prediction result by reference to the rate-distortion optimization.

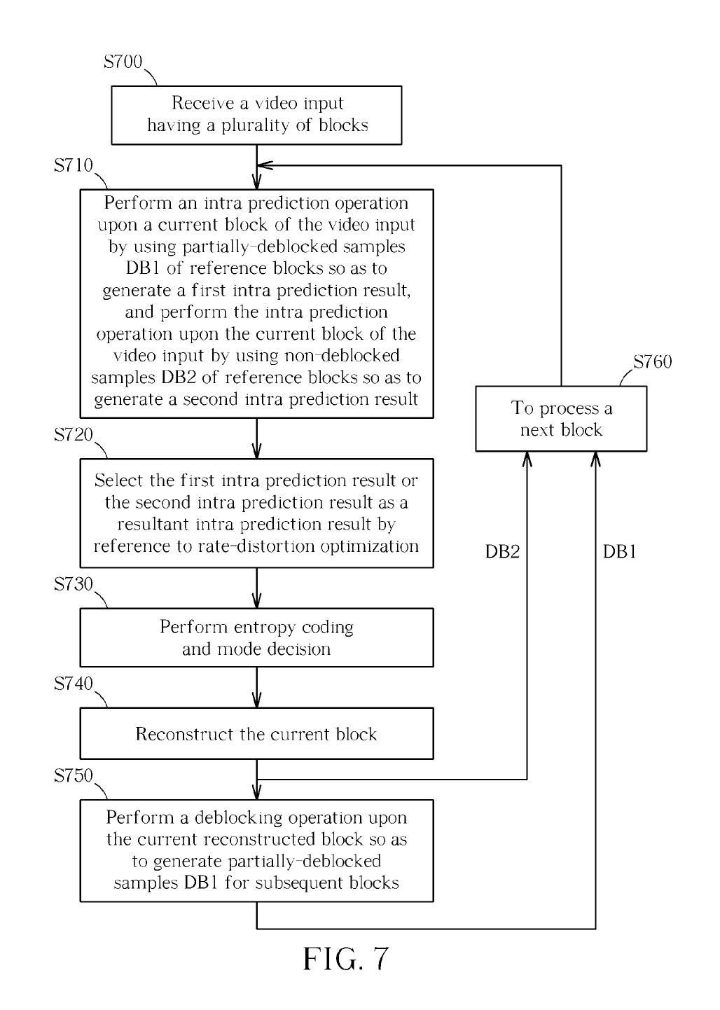

Please refer to FIG. 7. FIG. 7 is a flowchart illustrating a method of intra prediction for video encoding according to an embodiment of the present disclosure. The method includes, but is not limited to, the following steps:

Step S700: Receive a video input having a plurality of blocks.

Step S710: Perform an intra prediction operation upon a current block of the video input by using partially-deblocked samples of reference blocks so as to generate a first intra prediction result, and perform the intra prediction operation upon the current block of the video input by using non-deblocked samples of reference blocks so as to generate a second intra prediction result.

Step S720: Select the first intra prediction result or the second intra prediction result as a resultant intra prediction result by reference to rate-distortion optimization.

Step S730: Perform entropy coding and mode decision.

Step S740: Reconstruct the current block.

Step S750: Perform a deblocking operation upon the current reconstructed block so as to generate partially-deblocked samples for subsequent blocks.

Step S760: To process a next block until the last block of the video input by starting from Step S710.

How each element operates can be known by collocating the steps shown in FIG. 7 and the elements shown in FIG. 6, and further description is omitted here for brevity. Be noted that the steps of the flowchart shown in FIG. 7 are similar to the steps of the flowchart shown in FIG. 5, and the difference between them are listed as below. In Step S710 of FIG. 7, the intra prediction module 610 adopts both the partially-deblocked samples DB1 of reference blocks as well as the non-deblocked samples DB2 of reference blocks to perform the intra prediction operation in order to generate the first intra prediction result PR1 and the second intra prediction result PR2, respectively. After that, the selecting unit 620 selects the first intra prediction result PR1 or the second intra prediction result PR2 as a resultant intra prediction result by reference to rate-distortion optimization (Step S720). In Step S730, the entropy coding module 470 performs entropy coding and the mode decision module 430 performs mode decision. In addition, the non-deblocked samples DB2 are generated after reconstructing the plurality of blocks by the reconstruction module 460 (Step S740), and the partially-deblocked samples DB1 are generated after performing the deblocking operation upon the designated reconstructed block (Step S750).

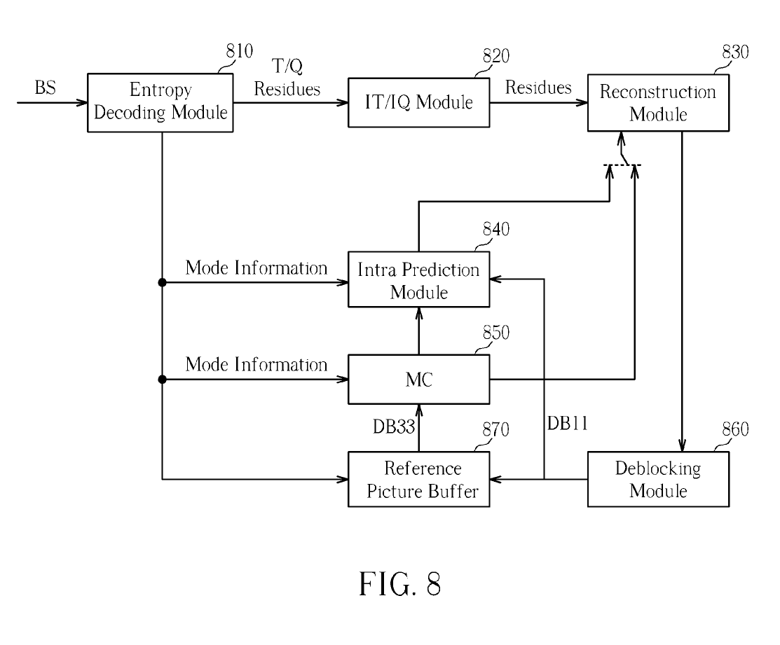

Please refer to FIG. 8. FIG. 8 is a block diagram illustrating a video decoder 800 according to an embodiment of the present disclosure. As shown in FIG. 8, the video decoder 800 includes, but is not limited to, an entropy decoding module 810, an inverse transformation/inverse quantization module (IT/IQ module) 820, a reconstruction module 830, an intra prediction module 840, a motion compensation module (MC) 850, a deblocking module 860, and a reference picture buffer 870. Be noted that, since operations of the entropy decoding module 810, the IT/IQ module 820, the MC 850 are already well-known to a person of average skill in the pertinent art, therefore, additional description is omitted here for brevity.

First, the entropy decoding module 810 receives a bitstream BS, and performs entropy decoding upon the bitstream BS to generate T/Q residues. The IT/IQ 820 is coupled to the entropy decoding module 810, for performing inverse transformation and inverse quantization upon the T/Q residues to generate residues. The reconstruction module 830 is coupled to the IT/IQ module 820, for reconstructing a plurality of blocks. For example, after a designated block B of the plurality of blocks is reconstructed by the reconstruction module 830, a designated reconstructed block B′ is generated. After the designated block B is reconstructed by the reconstruction module 830 to generate the designated reconstructed block B′, the deblocking module 860 performs a deblocking operation upon the designated reconstructed block B′ so as to generate partially-deblocked samples DB11, which represents reference blocks with at least one sample being deblocked in the present disclosure. The reference picture buffer 870 is coupled to the deblocking module 860, for storing the partially-deblocked samples DB11 or fully-deblocked samples of reference blocks. The deblocking module 860 updates the partially-deblocked samples DB11 to generate fully-deblocked samples DB33 for MC 850. The reference picture buffer 870 provides partially-deblocked samples DB11 for the intra prediction module 840 and provides the fully-deblocked samples DB33 for the MC 850 for subsequent operations. Furthermore, the designated reconstructed blocks B′ can also be called as non-deblocked samples because it has not been inputted into and processed by the deblocking module 860.

What calls for special attention is that, in the embodiment, the intra prediction module 840 performs an intra prediction operation upon a current block by using the partially-deblocked samples DB11 of reference blocks rather than using the non-deblocked samples DB22. If the non-deblocked samples are used for the intra prediction operation, extra line buffers are required in order to store the non-deblocked samples as reference pixels for decoding next neighboring blocks. For this reason, extra line buffers can be saved when performing the intra prediction operation according to the partially-deblocked samples DB11. Additionally, a higher decoding efficiency may be achieved.

As the name implies, the abovementioned non-deblocked samples DB22 indicate that they are pixels of blocks with all neighboring edges not been deblocked; the fully-deblocked samples DB33 indicate that they are pixels of blocks with all neighboring edges been fully deblocked; while the partially-deblocked samples DB11 indicate that they are pixels of blocks with their left edges and upper edges been deblocked and their right edges and lower edges not been deblocked.

Please also note that the bitstream BS may conform to an H.264/AVC specification, and thus the video decoder 800 can be implemented by an H.264/AVC decoder, but the present disclosure is not limited to this only, any later version of video coding can also apply localized deblocking concept to improve decoding performance. Furthermore, in one embodiment, the abovementioned designated block B may be a macroblock, and the designated reconstructed block B′ may be a macroblock as well. In another embodiment, the designated block B may be a transform block, and the designated reconstructed block B′ may be a transform block as well. But this in no way should be considered as a limitation of the present disclosure. Certainly, those skilled in the art should appreciate that various modifications of the size of the designated block B as well as the designated reconstructed block B′ may be made without departing from the spirit of the present disclosure.

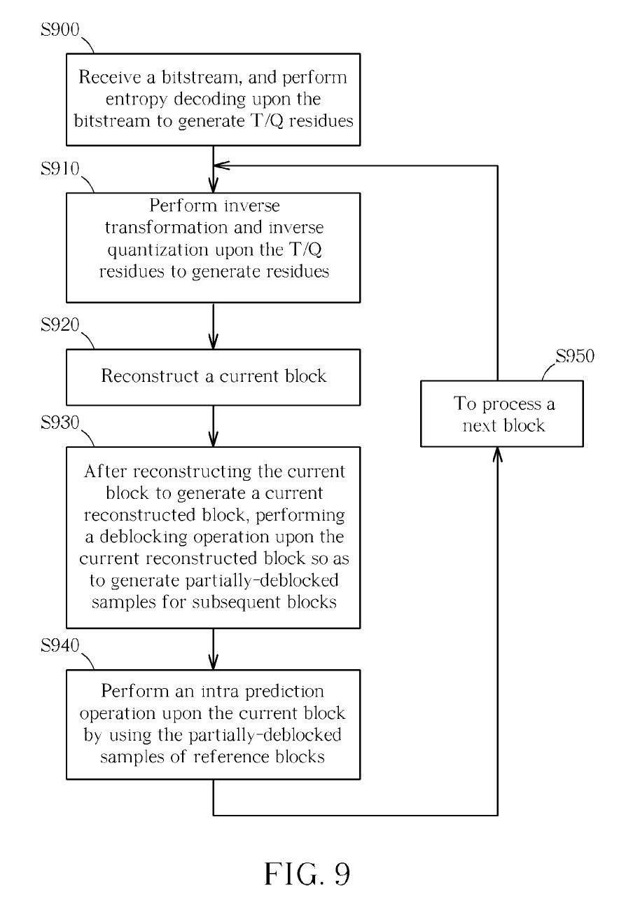

Please refer to FIG. 9. FIG. 9 is a flowchart illustrating a method of intra prediction for video decoding according to another embodiment of the present disclosure. The method includes, but is not limited to, the following steps:

Step S900: Receive a bitstream, and perform entropy decoding upon the bitstream to generate T/Q residues.

Step S910: Perform inverse transformation and inverse quantization upon the T/Q residues to generate residues.

Step S920: Reconstruct a current block.

Step S930: After reconstructing the current block to generate a current reconstructed block, perform a deblocking operation upon the current reconstructed block so as to generate partially-deblocked samples for subsequent blocks.

Step S940: Perform an intra prediction operation upon the current block by using the partially-deblocked samples of reference blocks.

Step S950: To process a next block until the last block of a frame by starting from Step S910.

The deblocking block in this embodiment can be a macroblock, a transform-block, or any other block sizes, that is the same or different from the size of a coding block or transform block.

How each element operates can be known by collocating the steps shown in FIG. 9 and the elements shown in FIG. 8, and further description is omitted here for brevity. Be noted that the step S900 is executed by the entropy decoding module 810, the step S910 is executed by the IT/IQ module 820, the step S920 is executed by the reconstruction module 830, the step S930 is executed by deblocking module 860, and the step S940 is executed by the intra prediction module 840. Furthermore, in this embodiment, the intra prediction operation is performed upon the current block by using the partially-deblocked samples DB11 of reference blocks.

The embodiment above is presented merely for describing features of the present disclosure, and in no way should be considered as limitations of the scope of the present disclosure. Certainly, people skilled in the art will readily appreciate that other designs for implementing the video decoder 800 are feasible.

In another embodiment, when intra compensation is allowed in video decoding, a current block may reference to a reference block in the same frame that is fully-deblocked or a reference block that is only partially-deblocked.

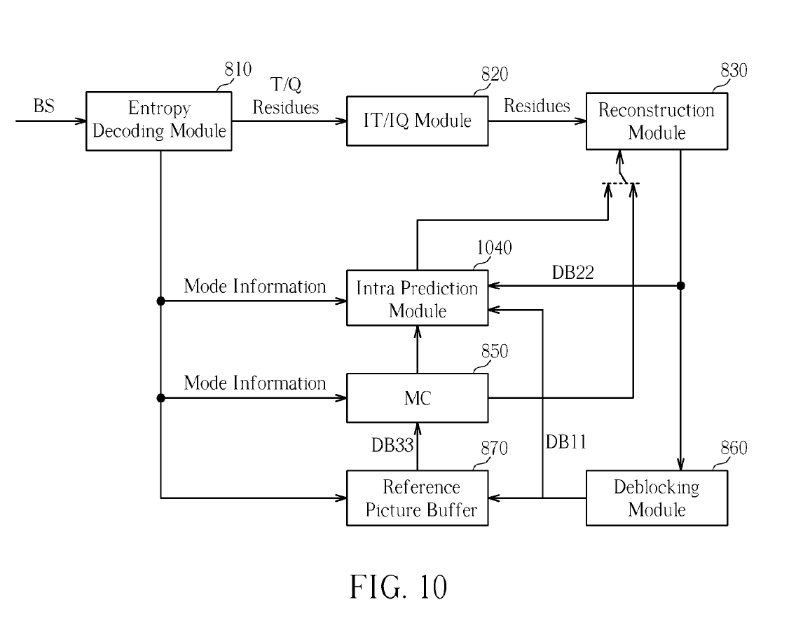

Please refer to FIG. 10. FIG. 10 is a block diagram illustrating a video decoder 1000 according to another embodiment of the present disclosure. In FIG. 10, the architecture of the video decoder 1000 is similar to that of the video decoder 800 shown in FIG. 8, and the difference between them is that the intra prediction 1040 further receives non-deblocked samples DB22 from the reconstruction module 830 as well as partially-deblocked samples DB11. In this embodiment, both the partially-deblocked samples DB11 and the non-deblocked samples DB22 of reference blocks can be provided to the intra prediction module 1040. The intra prediction module 1040 performs the intra prediction operation upon the current block by using either the partially-deblocked samples DB11 or the non-deblocked samples DB22 of reference blocks according to an index. In one embodiment, the index may be parsed from the bitstream by the entropy decoding module 810; or in another embodiment, the index may be derived from computing and comparing intra prediction results corresponding to the partially-deblocked samples DB11 and the non-deblocking samples DB33. A selecting unit (not shown) in the intra prediction module 1040 selects to use the partially-deblocked sample DB11 or the non-deblocked samples DB22 to generate intra prediction result, for example, by reference to rate-distortion optimization.

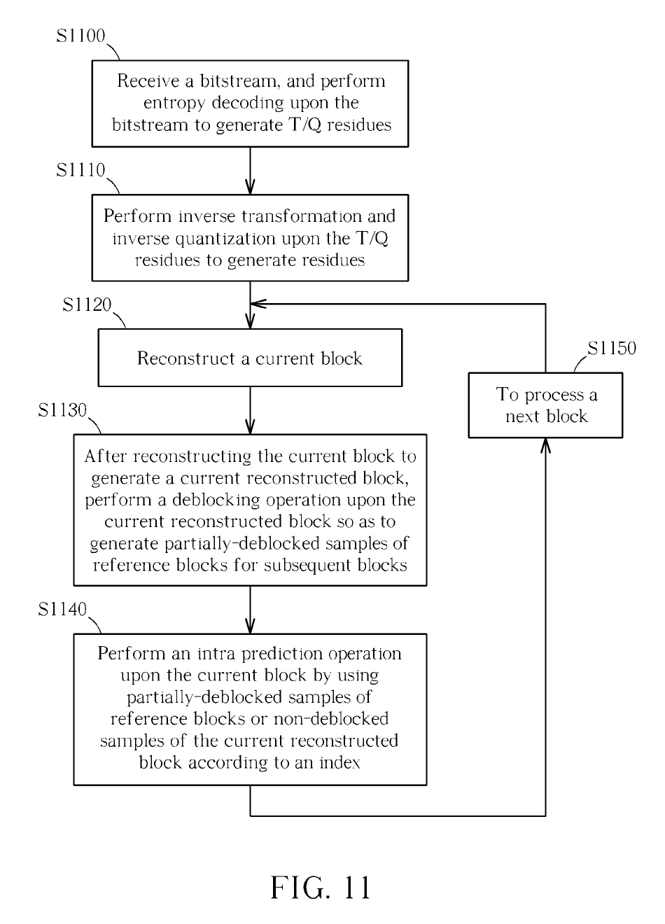

Please refer to FIG. 11. FIG. 11 is a flowchart illustrating a method of intra prediction for video decoding according to another exemplary embodiment of the present disclosure. The method includes, but is not limited to, the following steps:

Step S1100: Receive a bitstream, and perform entropy decoding upon the bitstream to generate T/Q residues.

Step S1110: Perform inverse transformation and inverse quantization upon the T/Q residues to generate residues.

Step S1120: Reconstruct a current block.

Step S1130: After reconstructing the current block to generate a current reconstructed block, perform a deblocking operation upon the current reconstructed block so as to generate partially-deblocked samples of reference blocks for subsequent blocks.

Step S1140: Perform an intra prediction operation upon the current block by using partially-deblocked samples of reference blocks or non-deblocked samples of the current reconstructed block according to an index.

Step S1150: To process a next block until the last block of a frame by starting from Step S1110.

How each element operates can be known by collocating the steps shown in FIG. 11 and the elements shown in FIG. 10, and further description is omitted here for brevity. Be noted that the steps of the flowchart shown in FIG. 11 are similar to the steps of the flowchart shown in FIG. 9, and the difference between them are listed as below. In Step S1140 of FIG. 11, the intra prediction module 1040 is capable of referencing to either the partially-deblocked samples DB11 of reference blocks or the non-deblocked samples DB22 of reference blocks to perform the intra prediction operation.

Please note that, the steps of the abovementioned flowcharts are merely practicable embodiments of the present disclosure, and in no way should be considered to be limitations of the scope of the present disclosure. These methods can include other intermediate steps or several steps can be merged into a single step without departing from the spirit of the present disclosure.

The abovementioned embodiments are presented merely for describing features of the present disclosure, and in no way should be considered to be limitations of the scope of the present disclosure. In summary, the present disclosure provides a video encoder and a related method for intra prediction. By performing the localized deblocking operation right after one macroblock (or one transform block) is encoded, a large frame buffer is not required and it is good for pipelined or parallel encoder architectures. In addition, extra line buffers can be saved by performing the intra prediction operation according to the partially-deblocked samples DB1 of reference blocks. Furthermore, both the partially-deblocked samples DB1 as well as the non-deblocked samples DB2 of reference blocks can be inputted into the intra prediction module to perform the intra prediction operation in order to generate the first intra prediction result PR1 and the second intra prediction result PR2, respectively, and a selecting unit can be adopted for selecting the first intra prediction result PR1 or the second intra prediction result PR2 by reference to rate-distortion optimization. Therefore, a goal of getting a higher encoding/decoding efficiency may be achieved.

Those skilled in the art will readily observe that numerous modifications and alterations of the device and method may be made while retaining the teachings of the disclosure. Accordingly, the above disclosure should be construed as limited only by the metes and bounds of the appended claims.

1. A method of intra prediction for video encoding, comprising:
receiving a video input having a plurality of blocks;
encoding and reconstructing the plurality of blocks one by one;
after encoding and reconstructing a designated block of the plurality of blocks to generate a designated reconstructed block, performing a deblocking operation upon the designated reconstructed block so as to generate a reference block with at least one sample being deblocked; and
performing an intra prediction operation upon a current block of the plurality of blocks by using samples of the reference block generated by the deblocking operation so as to generate a first intra prediction result.

2. The method of claim 1, wherein the designated block is a macroblock, and the designated reconstructed block is a macroblock.

3. The method of claim 1, wherein the designated block is a transform block, and the designated reconstructed block is a transform block.

4. The method of claim 1, wherein the reference block comprises pixels in left edges and upper edges been deblocked.

5. The method of claim 1, further comprising:
performing the intra prediction operation upon the current block of the plurality of blocks by using non-deblocked samples of the designated reconstructed block so as to generate a second intra prediction result; and
selecting the first intra prediction result or the second intra prediction result as a resultant intra prediction result.

6. A video encoder, comprising:
a reconstruction module, for reconstructing a video input having a plurality of blocks, wherein after a designated block of the plurality of blocks is reconstructed by the reconstruction module, a designated reconstructed block is generated;
a deblocking module, coupled to the reconstruction module, for performing a deblocking operation upon the designated reconstructed block so as to generate a reference block with at least one sample being deblocked; and
an intra prediction module, for receiving the video input and for performing an intra prediction operation upon a current block of the plurality of blocks by using samples of the reference block generated by the deblocking operation so as to generate a first intra prediction result.

7. The video encoder of claim 6, wherein the designated block is a macroblock, and the designated reconstructed block is a macroblock.

8. The video encoder of claim 6, wherein the designated block is a transform block, and the designated reconstructed block is a transform block.

9. The video encoder of claim 6, wherein the reference block comprises pixels in left edges and upper edges been deblocked.

10. The video encoder of claim 6, wherein the intra prediction module is further used for performing the intra prediction operation upon the current block of the plurality of blocks by using non-deblocked samples of the designated reconstructed block so as to generate a second intra prediction result; and the video encoder further comprises:
a selecting unit, coupled to the intra prediction module, for selecting the first intra prediction result or the second intra prediction result as a resultant intra prediction result.

11. A method of intra prediction for video decoding, comprising:
receiving a bitstream, and performing entropy decoding upon the bitstream to generate transformation and quantization residues (T/Q residues);
performing inverse transformation and inverse quantization upon the T/Q residues to generate residues;
reconstructing a plurality of blocks one by one;
after reconstructing a designated block to generate a designated reconstructed block, performing a deblocking operation upon the designated reconstructed block so as to generate a reference block with at least one sample being deblocked; and
performing an intra prediction operation upon a current block by using samples of the reference block generated by the deblocking operation.

12. The method of claim 11, wherein the designated block is a macroblock, and the designated reconstructed block is a macroblock.

13. The method of claim 11, wherein the designated block is a transform block, and the designated reconstructed block is a transform block.

14. The method of claim 11, wherein the reference block comprises pixels in left edges and upper edges been deblocked.

15. The method of claim 11, further comprising:
performing the intra prediction operation upon the current block by using non-deblocked samples of the designated reconstructed block; and
outputting an intra prediction result according to an index.

16. A video decoder, comprising:
an entropy decoding module, for receiving a bitstream and for performing entropy decoding upon the bitstream to generate T/Q residues;
an inverse transformation and inverse quantization module (IT/IQ module), coupled to the entropy decoding module, for performing inverse transformation and inverse quantization upon the T/Q residues to generate residues;
a reconstruction module, coupled to the IT/IQ module, for reconstructing a plurality of blocks, wherein after a designated block is reconstructed, a designated reconstructed block is generated;
a deblocking module, coupled to the reconstruction module, for performing a deblocking operation upon the designated reconstructed block so as to generate a reference block with at least one sample being deblocked; and
an intra prediction module, for performing an intra prediction operation upon a current block by using samples of the reference block generated by the deblocking operation.

17. The video decoder of claim 16, wherein the designated block is a macroblock, and the designated reconstructed block is a macroblock.

18. The video decoder of claim 16, wherein the designated block is a transform block, and the designated reconstructed block is a transform block.

19. The video decoder of claim 16, wherein the reference block comprises pixels in left edges and upper edges been deblocked.

20. The video decoder of claim 16, wherein the intra prediction module performs the intra prediction operation upon the current block by using non-deblocked samples of the designated reconstructed block; and the intra prediction module outputs an intra prediction result according to an index.
